(19) United States
(12) Patent Application Publication
(10) Pub. No.: US 2026/0179556 A1
(43) Pub. Date: Jun. 25, 2026

(54) ELECTRO-OPTICAL DEVICE AND ELECTRONIC APPARATUS

(71) Applicant: SEIKO EPSON CORPORATION, Tokyo (JP)

(72) Inventor: Hitoshi OTA, SHIOJIRI-SHI (JP)

(73) Assignee: SEIKO EPSON CORPORATION, Tokyo (JP)

(21) Appl. No.: 19/422,490

(22) Filed: Dec. 17, 2025

(30) Foreign Application Priority Data
Dec. 19, 2024 (JP) 2024-224104

(51) Int. Cl. G09G 3/3233

(52) U.S. Cl. CPC G09G 3/3233; G09G 2300/0426; G09G 2310/08; G09G 2320/02

(57) ABSTRACT

A feed line, a scan line, and a control line are shared by a certain pixel cluster section and a pixel cluster section adjacent in an X direction to each other. The feed line supplies a power supply voltage of a light emitting element provided to the pixel cluster section, and a control signal designating a light emission period of the light emitting element is supplied to the control line. The feed line, the scan line which is a relay wiring line of the scan line, and the control line which is a relay wiring line of the control line overlap each other in plan view between a certain pixel cluster section and the pixel cluster section adjacent in the X direction to each other.

The present application is based on, and claims priority from JP Application Serial Number 2024-224104, filed Dec. 19, 2024, the disclosure of which is hereby incorporated by reference herein in its entirety.

### BACKGROUND

### 1. Technical Field

The present disclosure relates to an electro-optical device and an electronic apparatus.

### 2. Related Art

An electro-optical device using, for example, an organic light emitting diode (OLED) as a light emitting element to be used for display has been known. Such a light emitting element has a configuration in which a light-emitting functional layer is sandwiched between a pixel electrode and a common electrode.

In an electro-optical device using such a light emitting element, as a technique of achieving a see-through type in which an image (virtual image) is visually recognized while making it possible to visually recognize the external world, there has been known a technique of disposing a light-transmissive region around a region to be visually recognized as a pixel of the image (see, e.g., JP-A-2024-82376).

JP-A-2024-82376 is an example of the related art.

However, the technique described above does not mention how a wiring line connecting portions that function as pixels to each other is processed. Therefore, in the technique described above, there is a problem that the light-transmissive region which makes it possible to visually recognize the external world is narrowed to make it difficult to visually recognize the external world depending on the processing of the wiring line.

### SUMMARY

An electro-optical device according to an aspect of the present disclosure includes a feed line disposed along a first direction, a scan line disposed along the feed line, a first data line disposed along a second direction crossing the first direction, a second data line disposed along the second direction, a first pixel circuit disposed corresponding to an intersection of the scan line and the first data line, a second pixel circuit disposed corresponding to an intersection of the scan line and the second data line, and a feed line wiring section disposed in a region between the first pixel circuit and the second pixel circuit in the first direction in plan view and configured to transmit light, wherein the feed line and the scan line are disposed in the feed line wiring section, the first pixel circuit includes a first transistor, a second transistor, and a first light emitting element, the second pixel circuit includes a third transistor, a fourth transistor, and a second light emitting element, the second transistor is set in an ON state or an OFF state in accordance with a voltage of the scan line between the first data line and a first gate node of the first transistor, the fourth transistor is set in an ON state or an OFF state in accordance with a voltage of the scan line between the second data line and a second gate node of the third transistor, the first transistor controls a current being supplied from the feed line to the first light emitting element in accordance with a voltage of the first gate node, the third transistor controls a current being supplied from the feed line to the second light emitting element in accordance with a voltage of the second gate node, and the feed line and the scan line overlap each other in plan view in the feed line wiring section.

Further, an electro-optical device according to another aspect of the present disclosure includes a feed line disposed along a first direction, a first scan line disposed along the feed line, a second scan line disposed along the feed line, a first data line disposed along a second direction crossing the first direction, a second data line disposed along the second direction, a first pixel circuit disposed corresponding to an intersection of the first scan line and the first data line, a second pixel circuit disposed corresponding to an intersection of the first scan line and the second data line, a third pixel circuit disposed corresponding to an intersection of the second scan line and the first data line, a fourth pixel circuit disposed corresponding to an intersection of the second scan line and the second data line, and a data line wiring section disposed in a region between a pair of the first pixel circuit and the second pixel circuit and a pair of the third pixel circuit and the fourth pixel circuit in the second direction in plan view, and configured to transmit light, wherein the first pixel circuit includes a first transistor, a second transistor, and a first light emitting element, the second pixel circuit includes a third transistor, a fourth transistor, and a second light emitting element, the third pixel circuit includes a fifth transistor, a sixth transistor, and a third light emitting element, the fourth pixel circuit includes a seventh transistor, an eighth transistor, and a fourth light emitting element, the second transistor is set in an ON state or an OFF state in accordance with a voltage of the first scan line between the first data line and a first gate node of the first transistor, the fourth transistor is set in an ON state or an OFF state in accordance with a voltage of the first scan line between the second data line and a second gate node of the third transistor, the sixth transistor is set in an ON state or an OFF state in accordance with a voltage of the second scan line between the first data line and a third gate node of the fifth transistor, the eighth transistor is set in an ON state or an OFF state in accordance with a voltage of the second scan line between the second data line and a fourth gate node of the seventh transistor, the first transistor controls a current being supplied from the feed line to the first light emitting element in accordance with a voltage of the first gate node, the third transistor controls a current being supplied from the feed line to the second light emitting element in accordance with a voltage of the second gate node, the fifth transistor controls a current being supplied from the feed line to the third light emitting element in accordance with a voltage of the third gate node, the seventh transistor controls a current being supplied from the feed line to the fourth light emitting element in accordance with a voltage of the fourth gate node, and the first data line and the second data line overlap each other in plan view in the data line wiring section.

### BRIEF DESCRIPTION OF THE DRAWINGS

FIG. 1 is a perspective view showing a configuration of an electro-optical device according to an embodiment.

FIG. 2 is a diagram showing an electrical configuration of the electro-optical device.

FIG. 3 is a diagram showing an arrangement of pixel circuits in a pixel cluster section in a display region.

FIG. 4 is a diagram showing compartments of a display region in the electro-optical device.

FIG. 5 is a plan view showing an equivalent circuit to the pixel circuit.

FIG. 6 is a timing chart illustrating an operation of the electro-optical device.

FIG. 7 is a plan view showing a configuration of the pixel cluster section.

FIG. 8 is a plan view showing a configuration of a transverse wiring section.

FIG. 9 is a plan view showing a configuration of a longitudinal wiring section.

FIG. 10 is a plan view showing a configuration of a transmissive portion.

FIG. 11 is a partial cross-sectional view showing the configuration of the transverse wiring section.

FIG. 12 is a partial cross-sectional view showing the configuration of the longitudinal wiring section.

FIG. 13 is a perspective view illustrating a head-mounted display using the electro-optical device.

FIG. 14 is a diagram illustrating an optical configuration of the head-mounted display.

### DESCRIPTION OF EMBODIMENTS

An electro-optical device according to an embodiment will hereinafter be described with reference to the drawings. Note that in the drawings, dimensions and scales of the elements are appropriately made different from actual ones. Further, the embodiment described below is a preferable specific example, and therefore various technically preferable limitations are imposed thereon, however, the scope of the present disclosure is not limited to the embodiment unless there is a description that the present disclosure is limited thereto in particular in the following description.

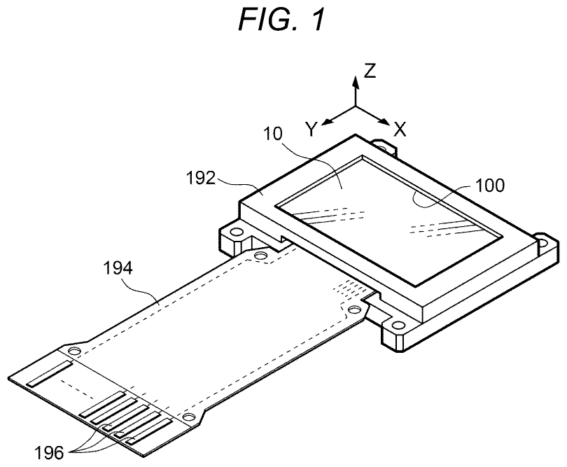

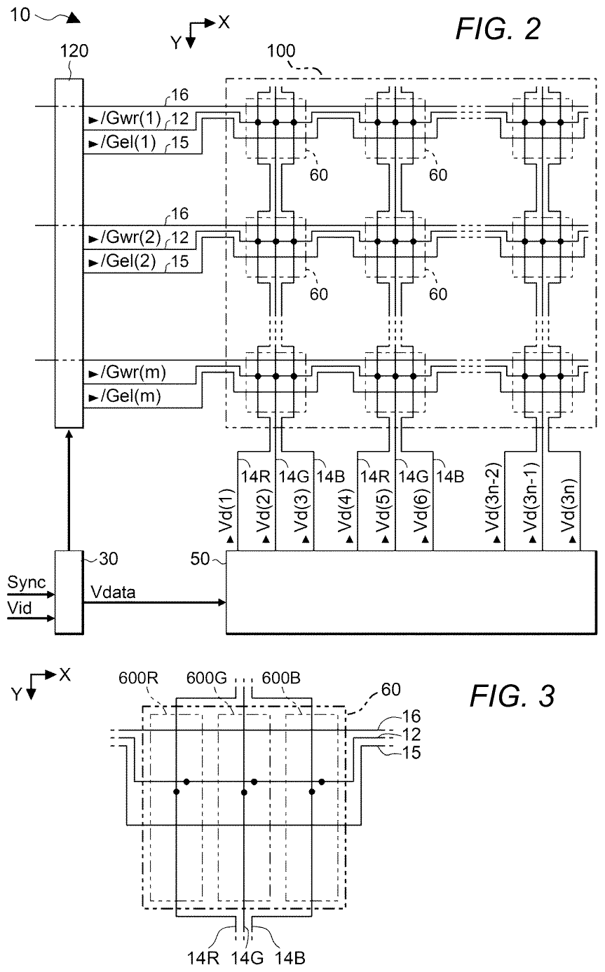

FIG. 1 is a perspective view illustrating an electro-optical device 10 according to the embodiment, and FIG. 2 is a block diagram illustrating a schematic electrical configuration of the electro-optical device 10.

The electro-optical device 10 is a micro display panel that displays a color image in a transmissive manner in, for example, a head-mounted display. The electro-optical device 10 drives an OLED with, for example, a transistor provided to an insulating substrate having transparency. As the insulating substrate, for example, quartz or sapphire is used, and the transistor is typically a thin-film transistor, but these are not limitations.

The electro-optical device 10 is housed in a case 192 shaped like a frame opening in a display region 100. One end of a flexible printed circuit (FPC) board 194 is coupled to the electro-optical device 10. The other end of the FPC board 194 is provided with a plurality of terminals 196 for coupling a host apparatus (not illustrated). When the plurality of terminals 196 are coupled to the host apparatus, video data, a synchronization signal, and so on are supplied from the host apparatus to the electro-optical device 10 via the FPC board 194.

Note that in the drawings, an X direction represents a transverse direction of the display screen. A Y direction means an extending direction of data lines, and represents a longitudinal direction in terms of the display screen. A two-dimensional plane defined by the X direction and the Y direction is a substrate surface of the insulating substrate. A Z direction is perpendicular to the substrate surface of the insulating substrate and is an exit direction of light emitted from the OLED. Further, in the present description, a plan view means that the insulating substrate is viewed from a direction opposite to the Z direction, and a cross-sectional view means that the insulating substrate is broken and viewed in a direction perpendicular to the substrate surface.

As illustrated in FIG. 2, the electro-optical device 10 is broadly divided into a control circuit 30, a data signal output circuit 50, the display region 100, and a scan line drive circuit 120.

In the display region 100, m rows of feed lines 16 are disposed along the X direction. The feed lines 16 supply a voltage Vel which is a power supply of the OLED. In the display region 100, pairs of the scan line 12 and the control line 15 are disposed along the X direction so as to correspond one-to-one to the feed lines 16. Note that although the scan line 12 and the control line 15 are disposed so as to partially be bent along the Y direction, it can be said that the scan line 12 and the control line 15 are disposed along the X direction from an electrical point of view. Note that m is an integer no smaller than 2.

In the display region 100, data lines 14R, 14G, and 14B are disposed. Among these, the data lines 14G are disposed along the Y direction. In addition, although the data lines 14R, 14B are disposed so as to partially be bent along the X direction, it can be said that the data lines 14R, 14B are disposed along the Y direction from an electrical point of view. The data lines 14R, 14G, and 14B are kept electrically insulated from the feed lines 16, the scan lines 12, and the control lines 15.

In the present embodiment, the data lines are grouped into three data lines 14R, 14G, and 14B. Defining the total number of groups as n, the total number of data lines is three times (3n) as large as n in the present embodiment. Note that n is an integer no smaller than 2. Further, in the present embodiment, m<(3n) is assumed for the sake of convenience.

In order to describe a row of the scan lines 12 in a generalized manner, an integer i no smaller than 1 and no larger than m is used. For example, the scan lines 12 may be referred to as first, second, third, . . . , (i-1)-th, i-th, . . . , (m-1)-th, and m-th rows in order from an upper side in the drawing in some cases.

Similarly, in order to describe a column of data lines, an integer j no smaller than 1 and no larger than n is used. For example, in order to distinguish the data lines, the data lines may be referred to as first, second, third, . . . , (3j-2)-th, (3j-1)-th, (3j)-th, . . . , (3n-2)-th, (3n-1)-th, and (3n)-th columns in order from the left in the drawing in some cases.

Further, regarding the data lines 14R, 14G, and 14B, in the case of a j-th group, the description is presented defining the (3j-2)-th column as a first series, the (3j-1)-th column as a second series, and the (3j)-th column as a third series in some cases. In other words, in the j-th group, the data line 14R in the first series is the (3j-2)-th column, the data line 14G in the second series is the (3j-1)-th column, and the data line 14B in the third series is the (3j)-th column.

Pixel cluster sections 60 are provided so as to correspond respectively to intersections of the m scan lines 12 and n groups of the data lines 14R, 14G, and 14B.

FIG. 3 is a plan view illustrating a configuration of the pixel cluster section 60. The pixel cluster section 60 has a configuration in which pixel circuits 600R, 600G, and 600B each having a rectangular shape are sequentially disposed along the X direction. In the rectangular shape of the pixel circuits 600R, 600G, and 600B, the X direction is a transverse side, and the Y direction is a longitudinal side.

The pixel circuit 600R is disposed so as to correspond to the intersection of the scan line 12 and the data line 14R, the pixel circuit 600G is disposed so as to correspond to the intersection of the scan line 12 and the data line 14G, and the pixel circuit 600B is disposed so as to correspond to the intersection of the scan line 12 and the data line 14B.

The pixel circuit 600R is a circuit that includes an OLED for emitting colored light in a red wavelength region, and controls light emission of the red OLED. Similarly, the pixel circuit 600G is a circuit that includes an OLED for emitting colored light in a green wavelength region, and controls light emission of the green OLED, and the pixel circuit 600B is a circuit that includes an OLED for emitting colored light in a blue wavelength region, and controls light emission of the blue OLED.

In the present embodiment, one color dot is expressed by one pixel cluster section 60. Specifically, one color dot is expressed by additive color mixing achieved by the red OLED emitting light in the pixel circuit 600R, the green OLED emitting light in the pixel circuit 600G, and the blue OLED emitting light in the pixel circuit 600B.

Therefore, in the present embodiment, a color image of (m longitudinal dots)×(n transverse dots) can be displayed.

Going back to the description of FIG. 2, the control circuit 30 inputs the video data Vin and the synchronization signal Sync from the host apparatus to control the data signal output circuit 50 and the scan line drive circuit 120.

The video data Vin is data that defines the color image of (m longitudinal dots)×(n transverse dots), and designates each gradation level of R, G, and B for one dot in, for example, 8 bits.

The synchronization signal Sync includes a vertical synchronization signal that indicates a start of vertical scanning of the video data Vid, a horizontal synchronization signal that indicates a start of horizontal scanning, and a dot clock signal that indicates a supply timing of one dot of the video data.

In the electro-optical device 10, one color dot of an image to be displayed and one color dot expressed by the pixel cluster section 60 correspond one-to-one to each other. Meanwhile, a brightness characteristic designated by the gradation level in the video data Vin and luminance characteristics of the red, green, and blue OLEDs provided to the pixel cluster section 60 do not necessarily match each other.

Therefore, the control circuit 30 performs up-conversion on 8 bits of the gradation level designated by the video data Vid into, for example, 10 bits in order to cause the OLED to emit light at the luminance according to that gradation level, and outputs the result as video data Vdata that designates the luminance of the OLED.

The scan line drive circuit 120 is a circuit for driving the pixel cluster sections 60 arranged in an m×n matrix row by row under the control of the control circuit 30. Specifically, the scan line drive circuit 120 sequentially outputs scanning signals/Gwr(1), /Gwr(2), /Gwr(3), . . . , /Gwr(m-1), and/Gwr(m) to the scan lines 12 of first, second, third, . . . , (m-1)-th, and m-th rows. In general, the scanning signal output to the scan line 12 of the i-th row is described as/Gwr(i).

In addition, the scan line drive circuit 120 sequentially outputs the control signals/Gel(1), /Gel(2), /Gel(3), . . . , /Gel(m-1), and/Gel(m) to the control lines 15 of first, second, third, . . . , (m-1)-th, and m-th rows in synchronization with output of the scanning signals/Gwr(1) to/Gwr(m). In general, the control signal output to the control line 15 of the i-th row is described as/Gel(i).

The data signal output circuit 50 is a circuit that outputs data signals of R, G, and B corresponding to one color dot expressed by that pixel cluster section 60 to the pixel cluster section 60 located in a row selected by the scan line drive circuit 120 in the order of the data lines 14R, 14G, and 14B.

Specifically, before a certain row is selected by the scan line drive circuit 120, the video data Vdata corresponding to that row is supplied to the data signal output circuit 50. The data signal output circuit 50 latches the video data Vdata corresponding to that row, and then converts the video data Vdata thus latched into analog data signals to output the analog data signals to the data lines when that row is selected.

Note that although not particularly illustrated, a power supply circuit is disposed outside the display region 100, and the power supply circuit generates the voltage Vel and a voltage Vct as the power for the control circuit 30, the scan line drive circuit 120, the data signal output circuit 50, and the OLEDs.

Further, in the drawing, the data signals output to the data lines 14 of the first, second, third, . . . , (3n-2)-th, (3n-1)-th, and (3n)-th columns are described, in order, as Vd(1), Vd(2), Vd(3), . . . , Vd(3n-2), Vd(3n-1), and Vd(3n). In general, for example, the data signal output to the data line 14G of the (3j-1)-th column is described as Vd(3j-1).

In the present embodiment, the pixel cluster sections 60 are arranged in a state of being separated from each other.

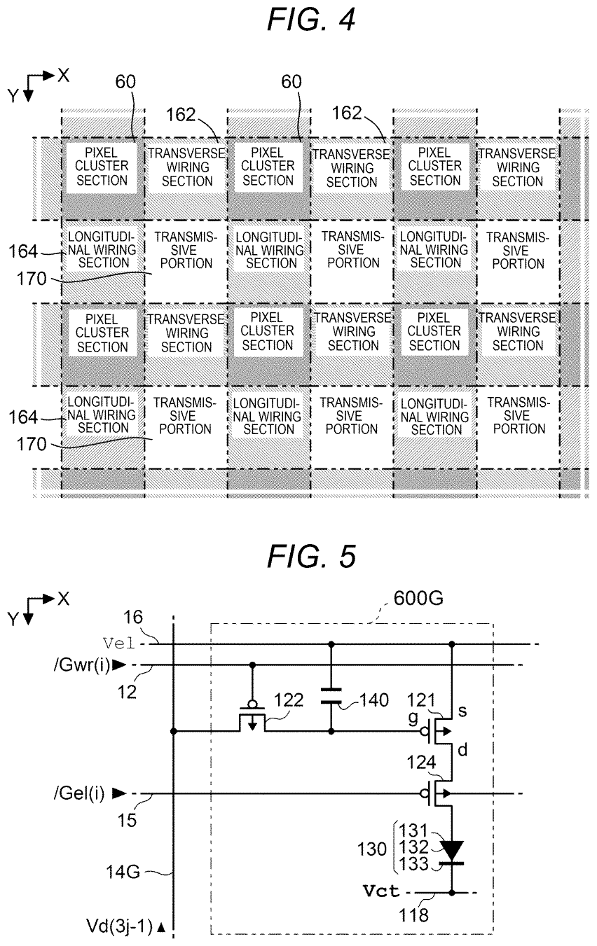

FIG. 4 is a plan view illustrating an arrangement of the pixel cluster sections 60 and so on in the display region 100. The pixel cluster sections 60 are arranged across transverse wiring sections 162 at the left and right sides in the drawing, and are arranged across longitudinal wiring sections 164 at the upper and lower sides.

In addition, transmissive portions 170 are arranged at the upper and lower sides of the transverse wiring sections 162. In other words, the transmissive portions 170 are arranged at the left and right sides of the longitudinal wiring sections 164.

The transverse wiring section 162 is a region through which the wiring lines constituting the feed line 16, the scan line 12, and the control line 15 pass, and transmits the light incident from the opposite side in the Z direction in other regions than the region in which the wiring lines are formed. In other words, the transverse wiring section 162 is disposed in a region between the pixel cluster sections 60 separated from each other in the X direction, and the wiring lines constituting the feed line 16, the scan line 12, and the control line 15 are disposed in the transverse wiring section 162. The transverse wiring section 162 corresponds to a “feed line wiring section” described in the appended claims.

The longitudinal wiring section 164 is a region through which the wiring lines constituting the data lines 14R, 14G, and 14B pass, and transmits the light in other regions than the region in which the wiring lines are formed similarly to the transverse wiring section 162.

The transmissive portion 170 is a region in which neither one of transistors, wiring lines, and so on is formed, and transmits the light incident from the opposite side in the Z direction.

The pixel circuits 600R, 600G, and 600G differ only in the color of the light emitted from the OLED, and are the same as each other in terms of an electrical configuration. Therefore, the pixel circuits 600R, 600G, and 600G will be described citing the pixel circuit 600G corresponding to the i-th row and the (3j-1)-th column as an example.

Note that the pixel circuit 600G in the i-th row and the (3j-1)-th column is provided to the pixel cluster section 60 in the i-th row and the j-th column.

FIG. 5 is a diagram illustrating the electrical configuration of the pixel circuit 600G. The pixel circuit 600G includes transistors 121, 122, and 124, an OLED 130, and a capacitive element 140. In the present embodiment, the transistors 121, 122, and 124 are all P-channel thin-film transistors.

In the transistor 121 of the pixel circuit 600G in the i-th row and the (3j-1)-th column, a gate node g is electrically coupled to a drain node of the transistor 122, a source node s is electrically coupled to the feed line 16, and a drain node d is electrically coupled to a drain node of the transistor 124.

In the present description, the phrase “electrically coupled” or simply “coupled” means a state in which two or more elements are directly or indirectly coupled to each other, or combined with each other.

In the transistor 122, a gate node is coupled to the scan line 12 in the i-th row, and a source node is coupled to the data line 14 in the (3j-1)-th column.

In the transistor 124, a gate node is coupled to the control line 15 in the i-th row, and the drain node is coupled to a pixel electrode 131 which is an anode of the OLED 130.

A cathode of the OLED 130 is a common electrode 118 common to all the pixel circuits 600R, 600G, and 600B. The voltage Vct is applied to the common electrode 118.

In the OLED 130, a light-emitting functional layer 132 is sandwiched between the pixel electrode 131 and a common electrode 133. In the present embodiment, white light is emitted from the light-emitting functional layer 132. Specifically, in the OLED 130, when a current flows from the anode to the cathode, holes injected from the anode and electrons injected from the cathode are recombined in the light-emitting functional layer 132 to generate excitons, and white light including wavelength regions of R, G, and B is generated.

A color filter corresponding to green colored light is disposed at an exit side of the OLED 130 provided to the pixel circuit 600G. Therefore, the white light emitted from the OLED 130 is visually recognized by an observer as the green colored light having been colored by the color filter.

Here, the OLED 130 provided to the pixel circuit 600G has been described, but a color filter corresponding to red colored light is disposed at the exit side of the OLED 130 corresponding to the red colored light, and a color filter corresponding to blue colored light is disposed at the exit side of the OLED 130 corresponding to the blue colored light.

Therefore, one color dot is expressed by the additive color mixing of the red, green, and blue OLEDs 130 provided to the pixel cluster section 60.

Note that although the configuration in which the OLED 130 emits the white light and the colored light having been colored by the color filter is visually recognized by the observer is adopted, it is possible to adopt, for example, a configuration in which the OLED 130 emits corresponding colored light or a configuration in which coloring by the color filter is used in combination.

When the electro-optical device 10 simply displays a monochrome image of only light and dark, the color filters described above are omitted.

One end of the capacitive element 140 is electrically coupled to the gate node g of the transistor 121, and the other end of the capacitive element 140 is electrically coupled to the feed line 16. Note that the role of the capacitive element 140 is to hold the voltage of the gate node g. Therefore, a parasitic capacitance may be used instead of actively adding the capacitive element 140.

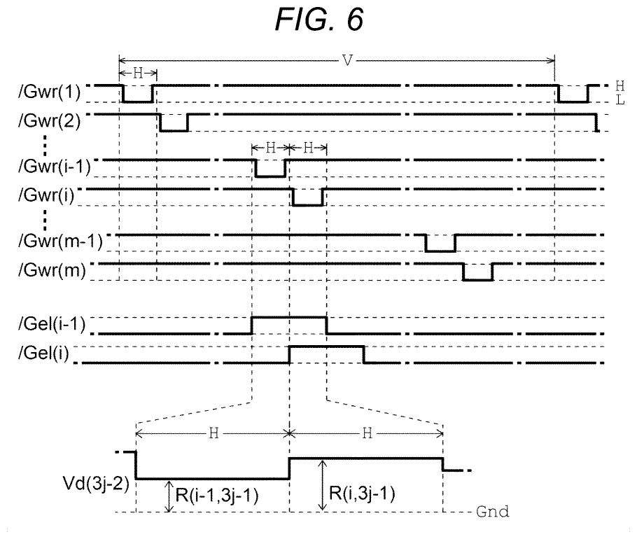

FIG. 6 is a timing chart illustrating an operation of the electro-optical device 10.

In the electro-optical device 10, m rows of the scan lines 12 are scanned one by one in a period of one frame (V) in the order of the first, second, third, . . . , and m-th rows. Specifically, as illustrated in the drawing, the scanning signals/Gwr(1), /Gwr(2), . . . , /Gwr(m-1), and /Gwr(m) are sequentially and exclusively set to an L level in each horizontal scanning period (H) by the scan line drive circuit 120.

Note that in the present embodiment, periods in which adjacent scanning signals out of the scanning signals /Gwr(1) to/Gwr(m) are set at the L level are temporally isolated from each other. Specifically, the scanning signal /Gwr(i-1) changes from the L level to an H level, and then, the next scanning signal/Gwr(i) turns to the L level at an interval. This interval corresponds to a horizontal blanking period.

In the present description, the period of one frame (V) refers to a period required to display one frame of an image designated by the video data Vid. When a length of the period of one frame (V) is the same as that of a vertical synchronization period, for example, when the frequency of the vertical synchronization signal contained in the synchronization signal Sync is 60 Hz, the length is 16.7 milliseconds corresponding to one cycle of the vertical synchronization signal. Further, the horizontal scanning period (H) is a time period during which each of the scanning signals/Gwr(1) to/Gwr(m) is set at the L level in turn, but for the sake of convenience, in the drawing, a start timing of the horizontal scanning period (H) is assumed to be substantially the center of the horizontal blanking period.

When a certain scanning signal out of the scanning signals/Gwr(1) to/Gwr(m), for example, the scanning signal/Gwr(i) supplied to the scan line 12 in the i-th row is set at the L level, the transistor 122 is set to an ON state in the pixel circuit 600G in the i-th row and the (3j-1)-th column in the case of, for example, the (3j-1)-th column. Therefore, the gate node g of the transistor 121 in that pixel circuit 600G is set in a state of being electrically coupled to the data line 14 in the (3j-1)-th column.

In the present description, the “ON state” of a transistor means that a source node and a drain node of the transistor are electrically closed to be in a low-impedance state. Further, an “OFF state” of a transistor means that a source node and a drain node are electrically opened to be in a high-impedance state.

In the horizontal scanning period (H) in which the scanning signal/Gwr(i) is set at the L level, the data signal output circuit 50 converts the video data Vdata that has been decomposed into R, G, and B into analog data signals Vd(1) to Vd(3n) to supply the analog data signals to the data lines of the first to (3n)-th columns. The video data Vdata decomposed into R, G, and B means three primary color components of a gradation level of one color dot represented by the video data Vid.

In the case of the (3j-1)-th column, the data signal output circuit 50 converts a gradation level G(i, j) of G out of the color dot components in the i-th row and the j-th column represented by the video data Vid into the analog data signal Vd(3j-1) to supply the analog data signal Vd(3j-1) to the data line 14G of the (3j-1)-th column.

Note that in the horizontal scanning period (H) in which the scanning signal/Gwr(i-1) one row before the scanning signal/Gwr(i) is set at the L level, the data signal output circuit 50 converts the gradation level G(i-1, j) of G out of the color dot components in the (i-1)-th row and the j-th column into the analog data signal Vd(3j-1) to supply the data signal Vd(3j-1) to the data line 14G of the (3j-1)-th column.

The voltage of the data signal Vd(3j-1) is applied to the gate node g of the transistor 121 in the pixel circuit 600G of the i-th row and the (3j-1)-th column via the data line 14G of the (3j-1)-th column.

Note that when the scanning signal/Gwr(i) is set at the H level, the transistor 122 is set in the OFF state, but the voltage of the data signal Vd(3j-1) applied to the gate node g of the transistor 121 is held by the capacitive element 140.

In the present embodiment, the control signal /Gel(i) is set at the L level in the next period. That is, the control signal/Gel(i) is set at the L level in a period from when one horizontal scanning period (H) elapses after the scanning signal/Gwr(i) is set at the H level to when the scanning signal/Gwr(i) is set at the L level again after one frame (V) period elapses.

When the control signal/Gel(i) is set at the L level, the transistor 124 is set in the ON state. Therefore, the transistor 121 causes a current according to the voltage between the gate node g and the source node s to flow through the OLED 130.

Even when the scanning signal Gwr(i) is set at the H level to set the transistor 122 in the OFF state, since the voltage of the data signal Vd(3j-2) is held by the capacitive element 140, the current continues to flow through the OLED 130G.

Therefore, in the pixel circuit 600G in the i-th row and the (3j-1)-th column, the OLED 130 continues to emit light at the luminance according to the voltage held by the capacitive element 140, that is, to the gradation level until the control signal/Gel(i) is set at the H level after the period of one frame (V) elapses.

Note that although the pixel circuit 600G in the i-th row and the (3j-1) column has been described here, the pixel circuits 600R, 600G, and 600B in the i-th row and other columns than the (3j-1)-th column also emit light with the luminance represented by the video data Vin.

Further, the OLEDs 130 in other rows than the i-th row also emit light with the luminance represented by the video data Vdata by sequentially setting the scanning signals/Gwr(1) to/Gwr(m) at the L level.

Therefore, in the electro-optical device 10, in the period of one frame (V), all the OLEDs 130 from the 1st row and 1st column to the m-th row and the (3n)-th column emit light with the luminance represented by the video data Vdata, and thus, one frame of image is displayed.

Note that the period in which each of the control signals/Gel(1) to/Gel(m) is set at the L level is a period in which the OLED emits the light. In other words, when the period in which each of the control signals/Gel(1) to/Gel(m) is set at the L level is long, the image displayed is bright, and conversely, when the period in which each of the control signals/Gel(1) to/Gel(m) is set at the L level is short, the image displayed is dark. Further, the period in which each of the control signals/Gel(1) to/Gel(m) is set at the L level may be intermittent.

Then, configurations of the pixel cluster section 60, the transverse wiring section 162, the longitudinal wiring section 164, and the transmissive portion 170 will be described.

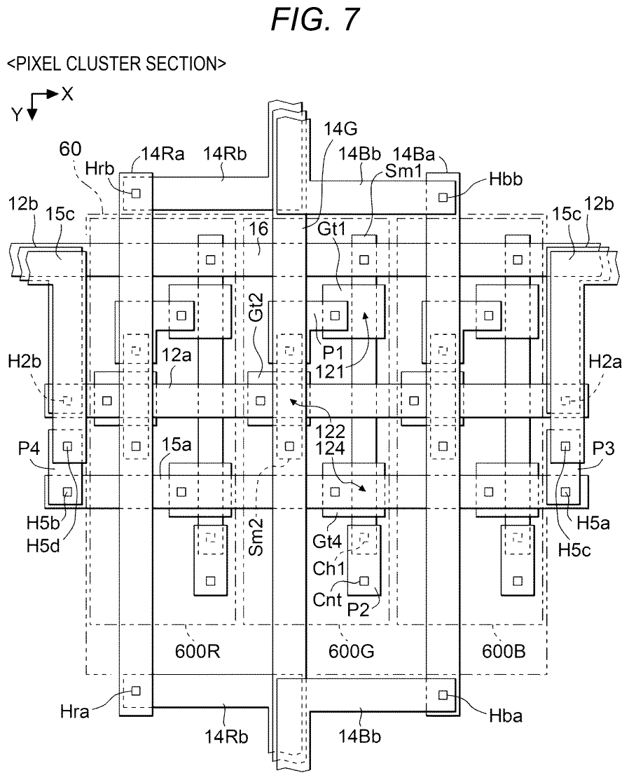

FIG. 7 is a plan view illustrating a configuration of the pixel cluster section 60.

The semiconductor layer or the conductive layer that electrically contributes in the electro-optical device 10 is formed in the order of the semiconductor layer, a gate electrode layer, a first wiring layer, a second wiring layer, and a third wiring layer from the insulating substrate. The insulating layer illustrated in the drawing is disposed between the layers. Further, in reality, a pixel electrode layer, the light-emitting functional layer, and the common electrode are formed in a step after forming the third wiring layer, but the description thereof will be omitted.

In the pixel cluster section 60, the pixel circuits 600R, 600G, and 600B are arranged in order along the X direction in the drawing. Note that since the pixel circuits 600R, 600G, and 600B are substantially the same in configuration in the pixel cluster section 60, the pixel circuit 600G will mainly be described as a representative.

In the pixel cluster section 60, semiconductor regions Sm1 and Sm2 that are shaped like islands and are elongated along the Y direction are provided by patterning the semiconductor layer. The semiconductor region Sm1 corresponds to the transistors 121 and 124, and the semiconductor region Sm2 corresponds to the transistor 122. Note that the semiconductor region Sm2 is hidden by the data line 14G in the second wiring layer in the case of the pixel circuit 600G, and is therefore indicated by a broken line.

By patterning the gate electrode layer, gate electrodes Gt1, Gt2, and Gt4 each having a rectangular shape are provided.

The gate electrode Gt1 is disposed so as to overlap the semiconductor region Sm1 in plan view, and serves as the gate node of the transistor 121. That is, in the semiconductor region Sm1, a region overlapping the gate electrode Gt1 in plan view becomes a channel region of the transistor 121.

The gate electrode Gt2 is disposed so as to overlap the semiconductor region Sm2 in plan view, and serves as the gate node of the transistor 122. That is, in the semiconductor region Sm2, a region overlapping the gate electrode Gt2 in plan view becomes a channel region of the transistor 122.

The gate electrode Gt4 is disposed so as to overlap the semiconductor region Sm1 in plan view, and serves as the gate node of the transistor 124. That is, in the semiconductor region Sm1, a region overlapping the gate electrode Gt4 in plan view becomes a channel region of the transistor 124.

In the semiconductor region Sm1, a region protruding upward from the gate electrode Gt1 in the drawing becomes the source node of the transistor 121. In the semiconductor region Sm1, a region that protrudes downward from the gate electrode Gt1 and protrudes upward from the gate electrode Gt4 serves as the drain node of the transistor 121 and the source node of the transistor 122. In the semiconductor region Sm1, a region protruding downward from the gate electrode Gt4 serves as the drain node of the transistor 124.

In the semiconductor region Sm2, an upper region protruding upward from the gate electrode Gt2 becomes the source node of the transistor 122. In the semiconductor region Sm2, a region protruding downward from the gate electrode Gt2 becomes the drain node of the transistor 122.

In the pixel cluster section 60, the feed line 16, a scan line 12a, a control line 15a, and relay wiring lines P1 are provided by patterning the first wiring layer.

Among these, the feed line 16 is common to the pixel cluster sections 60 provided to one row, and is provided in a straight line along the X direction by patterning only the first wiring layer. The feed line 16 is electrically coupled to the source node of the transistor 121 via a contact hole disposed at a point overlapping the semiconductor region Sm1.

Note that the contact hole is indicated by a quadrangular frame in the drawing.

The scan line 12a and the control line 15a are disposed along the X direction similarly to the feed line 16. However, unlike the feed line 16, the scan line 12a and the control line 15a are provided for each pixel cluster section 60.

The scan line 12a is disposed so as to overlap the gate electrode Gt2 in plan view. The scan line 12a is electrically coupled to the gate electrode Gt2 via a contact hole provided at a point overlapping the gate electrode Gt2.

The control line 15a is disposed so as to overlap the gate electrode Gt4 in plan view. The control line 15a is electrically coupled to the gate electrode Gt4 via a contact hole disposed at a point overlapping the gate electrode Gt4.

The relay wiring line P1 is disposed so as to overlap the gate electrode Gt1 and the drain node of the transistor 122 in plan view.

The relay wiring line P1 is electrically coupled to the gate electrode Gt1 via a contact hole provided at a point overlapping the gate electrode Gt1 in plan view, and is electrically coupled to the drain node of the transistor 122 via a contact hole disposed at a point overlapping the drain node in plan view.

In the pixel cluster section 60, data lines 14Ra, 14G, and 14Ba and relay wiring lines P2 are provided by patterning the second wiring layer.

Among these, the data line 14G is common to the pixel cluster sections 60 provided to one column, and is provided in a straight line along the Y direction by patterning only the second wiring layer. The data line 14G is electrically coupled to the source node of the transistor 122 via a contact hole disposed at a point overlapping the semiconductor region Sm2.

Similarly to the data line 14G, data lines 14Ra and 14Ba are disposed along the Y direction. However, unlike the data line 14G, the data lines 14Ra and 14Ba are provided for each pixel cluster section 60.

The data lines 14Ra and 14Ba are substantially the same as the data line 14G except that the data lines 14Ra and 14Ba are provided for each pixel cluster section 60. That is, in the case of the data line 14Ra, the data line 14Ra is electrically coupled to the source node of the transistor 122 via a contact hole disposed at a point overlapping the semiconductor region Sm2.

The relay wiring line P2 is disposed so as to overlap the drain node of the transistor 124 in plan view. The relay wiring line P2 is electrically coupled to the drain node with a contact hole Chl. Note that the relay wiring line P2 is electrically coupled to the pixel electrode 131 in an upper layer functioning as the anode in the OLED 130 via a contact hole Cnt.

In the pixel cluster section 60, wiring lines formed by patterning the third wiring layer are not provided. Further, in reality, relay wiring lines and the like for guiding signals to the pixel electrodes 131 in the fourth wiring layer and the subsequent layers are actually provided although omitted in FIG. 7.

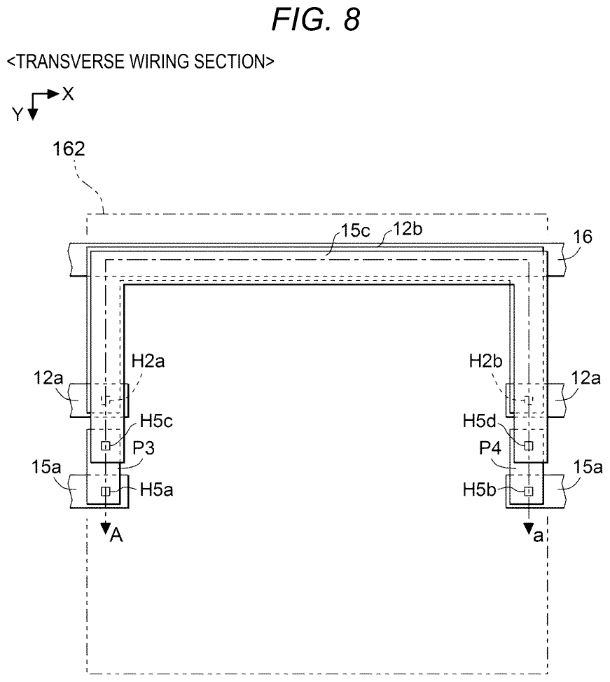

FIG. 8 is a plan view illustrating a configuration of the transverse wiring section 162.

In the transverse wiring section 162, the feed line 16 is provided by patterning the first wiring layer. As described above, the feed line 16 is common to the pixel cluster sections 60 provided to one row and is shaped like a straight line along the X direction. Therefore, the feed line 16 is disposed as an extension line from the pixel cluster section 60 adjacent in the X direction.

A part of the scan line 12a and the control line 15a provided by patterning the first wiring layer in the pixel cluster section 60 is extended to the transverse wiring section 162.

In the transverse wiring section 162, a scan line 12b and relay wiring lines P3 and P4 are provided by patterning the second wiring layer.

In the transverse wiring section 162, the scan line 12b is a wiring line that relays the scan line 12a in the pixel cluster section 60 at the left side and the scan line 12a in the pixel cluster section 60 at the right side.

The scan line 12b has a shape in which a portion along a boundary partitioning the transverse wiring section 162 from the pixel cluster section 60 at the left side, a portion overlapping the feed line 16 in plan view, and a portion along a boundary partitioning the transverse wiring section 162 from the pixel cluster section 60 at the right side are integrally patterned.

One end of the scan line 12b is coupled to the scan line 12a extending from the pixel cluster section 60 at the left side via a contact hole H2a. The other end of the scan line 12b is coupled to the scan line 12a extending from the pixel cluster section 60 at the right side via a contact hole H2b.

Therefore, the scan line 12 is shared in the pixel cluster sections 60 in one row with repetitive patterns of the scan lines 12a and the scan lines 12b in the X direction in the drawing.

The relay wiring line P3 is disposed so as to overlap the control line 15a extended from the pixel cluster section 60 at the left side in plan view. The relay wiring line P3 is coupled to the control line 15a via a contact hole H5a.

The relay wiring line P4 is disposed so as to overlap the control line 15a extended from the pixel cluster section 60 at the right side in plan view. The relay wiring line P4 is coupled to the control line 15a via a contact hole H5b.

In the transverse wiring section 162, a control line 15c is provided by patterning the third wiring layer.

In plan view, the control line 15c has a shape in which a portion overlapping the relay wiring line P3 along the boundary partitioning the transverse wiring section 162 from the pixel cluster section 60 at the left side, a portion overlapping the feed line 16 and the scan line 12b, and a portion overlapping the relay wiring line P4 along the boundary partitioning the transverse wiring section 162 from the pixel cluster section 60 at the right side are integrally patterned.

One end of the control line 15c is coupled to the relay wiring line P3 via a contact hole H5c, and the other end of the control line 15c is coupled to the relay wiring line P4 via a contact hole H5d.

Therefore, the control line 15 is shared in the pixel cluster sections 60 in one row by repetitive patterns of the control lines 15a, the relay wiring lines P3, the control lines 15c, and the relay wiring lines P4 in the X direction in the drawing.

In the transverse wiring section 162, the scan line 12b and the control line 15c partially overlap the feed line 16 shaped like a straight line in plan view. Therefore, in the present embodiment, it is possible to ensure a larger area through which the light is transmitted in the transverse wiring section 162 compared to a configuration in which the scan line 12b and the control line 15c do not overlap the feed line 16 in plan view.

Note that the configuration in which the scan line 12b and the control line 15c do not overlap the feed line 16 in plan view specifically refers to a configuration in which the scan line 12 and the control line 15 extend linearly in the X direction similarly to the feed line 16.

FIG. 11 is a partial cross-sectional view of the electro-optical device 10 broken along a line A-a in FIG. 8, and illustrates the first wiring layer to the third wiring layer similarly to FIG. 8.

As shown in the drawing, a first insulating layer 181, a first wiring layer Ly1, a second insulating layer 182, a second wiring layer Ly2, a third insulating layer 183, a third wiring layer Ly3, and a fourth insulating layer 184 are stacked in this order on the insulating substrate.

As described above, the control line 15a, the scan line 12a, and the feed line 16 are provided by patterning the first wiring layer Ly1, the relay wiring line P3, the scan line 12b, and the relay wiring line P4 are provided by patterning the second wiring layer Ly2, and the control line 15c is provided by patterning the third wiring layer Ly3.

The scan line 12a is coupled to one end of the scan line 12b via the contact hole H2a penetrating the second insulating layer 182, and the other end of the scan line 12b is coupled to the scan line 12b in the pixel cluster section 60 at the right side as viewed in FIG. 7 via the contact hole H2b penetrating the second insulating layer 182.

The control line 15a is coupled to the relay wiring line P3 via the contact hole H5a that penetrates the second insulating layer 182, and the relay wiring line P3 is coupled to one end of the control line 15c via the contact hole H5c that penetrates the third insulating layer 183. The other end of the control line 15c is coupled to the relay wiring line P4 via the contact hole H5d that penetrates the third insulating layer 183, and the relay wiring line P4 is coupled to the control line 15a in the pixel cluster section 60 at the right side as viewed in FIG. 7 via the contact hole H5b that penetrates the second insulating layer 182.

Further, the scan line 12b and the control line 15c partially overlap the feed line 16 in plan view.

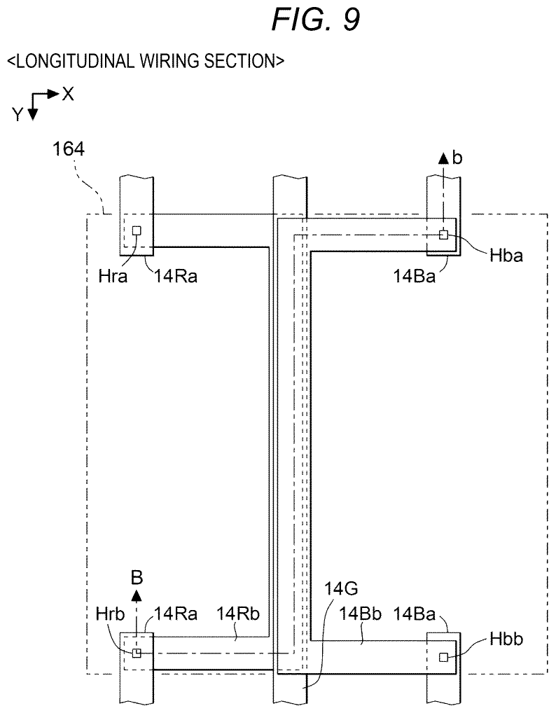

FIG. 9 is a plan view illustrating a configuration of the longitudinal wiring section 164.

In the longitudinal wiring section 164, a data line 14Rb is provided by patterning the first wiring layer.

In the longitudinal wiring section 164, the data line 14Rb is a wiring line that relays the data line 14Ra in the pixel cluster section 60 at the upper side and the data line 14Ra in the pixel cluster section 60 at the lower side.

A part of the data line 14Ra provided by patterning the second wiring layer in the pixel cluster section 60 is extended to the longitudinal wiring section 164.

The data line 14Rb has a shape in which a portion along a boundary partitioning the longitudinal wiring section 164 from the pixel cluster section 60 at the upper side, a portion overlapping the data line 14G in plan view, and a portion along a boundary partitioning the longitudinal wiring section 164 from the pixel cluster section 60 at the lower side are integrally patterned.

One end of the data line 14Rb is coupled to the data line 14Ra extended from the pixel cluster section 60 at the upper side via a contact hole Hra. The other end of the data line 14Rb is coupled to the data line 14Ra extended from the pixel cluster section 60 at the lower side via a contact hole Hrb.

Therefore, the data line 14R is shared in the pixel cluster sections 60 in one column by repetitive patterns of the data lines 14Ra and 14Rb in the Y direction in the drawing.

In the longitudinal wiring section 164, the data line 14G is provided by patterning the second wiring layer. As described above, the data line 14G is common to the pixel cluster sections 60 provided to one column, and is disposed linearly along the Y direction by patterning only the second wiring layer. Therefore, the data line 14G is disposed as an extension line from the pixel cluster section 60 adjacent in the Y direction.

In the longitudinal wiring section 164, a data line 14Bb is provided by patterning the third wiring layer.

In the longitudinal wiring section 164, the data line 14Bb is a wiring line that relays the data line 14Ba in the pixel cluster section 60 at the upper side and the data line 14Ba in the pixel cluster section 60 at the lower side.

A part of the data line 14Ba provided by patterning the second wiring layer in the pixel cluster section 60 is extended to the longitudinal wiring section 164.

The data line 14Bb has a shape in which a portion along the boundary partitioning the longitudinal wiring section 164 from the pixel cluster section 60 at the upper side, a portion overlapping the data line 14G in plan view, and a portion along the boundary partitioning the longitudinal wiring section 164 from the pixel cluster section 60 at the lower side are integrally patterned.

One end of the data line 14Bb is coupled to the data line 14Ba extended from the pixel cluster section 60 at the upper side via a contact hole Hba. The other end of the data line 14Bb is coupled to the data line 14Ba extended from the pixel cluster section 60 at the lower side via a contact hole Hbb.

Therefore, the data line 14B is shared in the pixel cluster sections 60 in one column by repetitive patterns of the data lines 14Ba and 14Bb in the Y direction in the drawing.

As described above, in the longitudinal wiring section 164, the data lines 14Rb and 14Bb partially overlap the data line 14G shaped like a straight line in plan view. Therefore, in the present embodiment, it is possible to ensure a larger area through which the light is transmitted in the longitudinal wiring section 164 compared to a configuration in which the data lines 14Rb and 14Bb do not overlap the data line 14G in plan view.

Note that the configuration in which the data lines 14Rb and 14Bb do not overlap the data line 14G in plan view refers to, for example, a configuration in which the data lines 14R and 14B extend linearly in the Y direction similarly to the data line 14G. The longitudinal wiring section 164 is disposed in a region between the pixel cluster sections 60 separated from each other in the Y direction, and the wiring lines constituting the data line 14G and the data lines 14R and 14B are disposed in the longitudinal wiring section 164. The longitudinal wiring section 164 corresponds to a “data line wiring section” described in the appended claims.

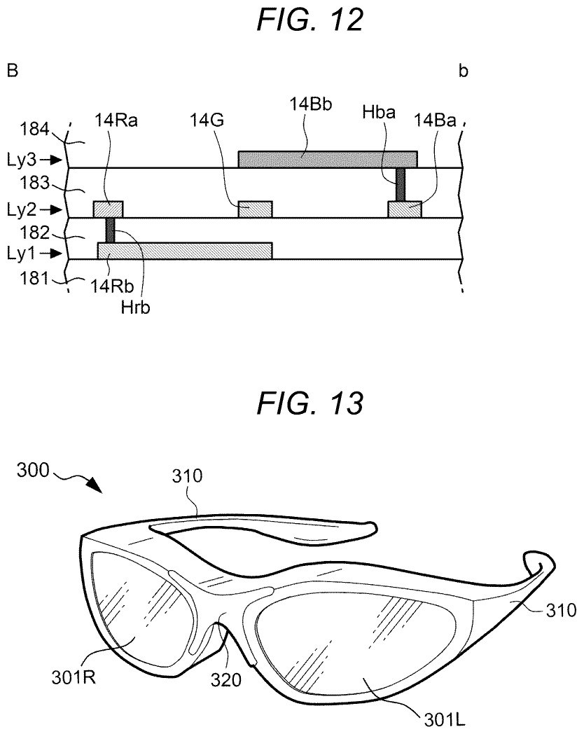

FIG. 12 is a partial cross-sectional view of the electro-optical device 10 broken along a line B-b in FIG. 9, and illustrates the first wiring layer to the third wiring layer similarly to FIG. 9.

As described above, the data line 14Rb is provided by patterning the first wiring layer Ly1, the data lines 14Ra, 14G, and 14Ba are provided by patterning the second wiring layer Ly2, and the data line 14Bb is provided by patterning the third wiring layer Ly3.

The data line 14Ra is coupled to the data line 14Rb located in the lower layer via the contact hole Hrb that penetrates the first insulating layer 181. A part of the data line 14Rb overlaps the data line 14G in plan view.

Meanwhile, the data line 14Ba is coupled to the data line 14Bb located in the upper layer via the contact hole Hba that penetrates the second insulating layer 182. A part of the data line 14Bb overlaps the data line 14G in plan view.

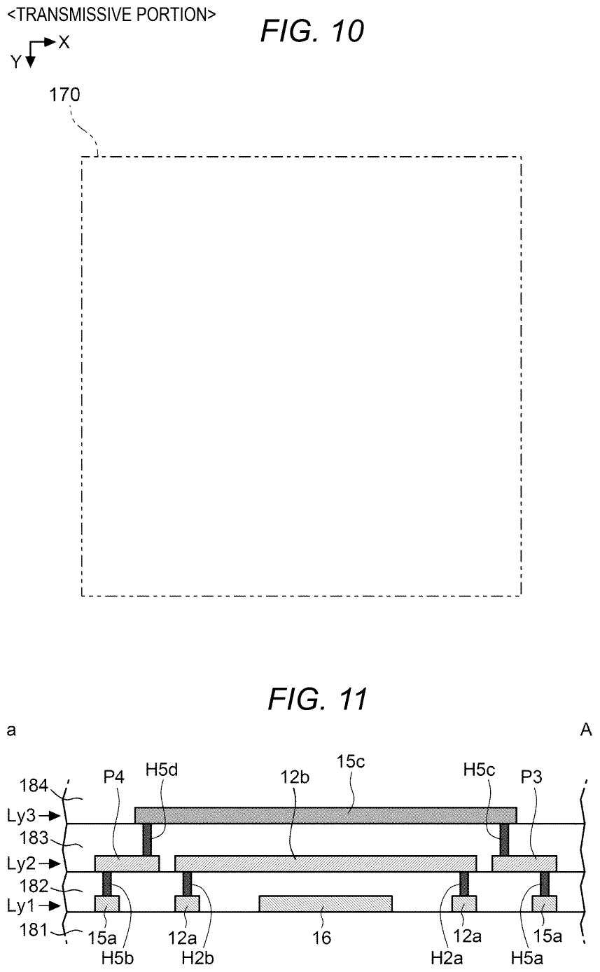

FIG. 10 is a plan view illustrating a configuration of the transmissive portion 170. As shown in the drawing, semiconductor layers or wiring layers are not disposed in the transmissive portion 170. Therefore, in the transmissive portion 170, it is possible to ensure a larger area through which the light is transmitted compared to the transverse wiring section 162 or the longitudinal wiring section 164 in which the wiring lines are present.

Therefore, in the present embodiment, since the large area through which the light is transmitted is ensured not only in the transmissive portion 170 but also in the transverse wiring section 162 and the longitudinal wiring section 164, it is possible to superimpose the real world by see-through on the display image by the electro-optical device 10 in a bright state.

In the present embodiment, the scan line 12 is shared in the pixel cluster sections 60 in one row by the repetitive patterns of the scan lines 12a and the scan lines 12b coupled via the contact holes in the X direction. Similarly, the control line 15 is shared in the pixel cluster sections 60 in one row by the repetitive patterns of the control lines 15a, the relay wiring lines P3, the control lines 15c, and the relay wiring lines P4 via the contact holes in the X direction.

On the other hand, since the feed line 16 is formed to have a straight line shape without passing through a contact hole and is shared in the pixel cluster sections 60 in one row, it is possible to achieve low resistance of the feed line 16 which supplies the voltage Vel as a power supply voltage of the OLEDs 130.

Therefore, since the voltage drop due to the resistance component of the feed line 16 is suppressed, it is possible to prevent the deterioration of the display quality due to the fluctuation of the voltage Vel in the display region 100.

In general, when loads such as resistances and parasitic capacitances in the data lines 14R, 14G, and 14B are not uniform, the brightness is different between the columns in the display image, which is visually recognized specifically as a longitudinal line, and thus the display quality is degraded.

In the present embodiment, the data line 14R is shared by the pixel circuits 600R in one column, the data line 14G is shared by the pixel circuits 600G in one column, and the data line 14B is shared by the pixel circuits 600B in one column. Further, in the present embodiment, in the longitudinal wiring section 164, the data lines 14R, 14G, and 14B in the same series overlap each other in plan view. Therefore, in the present embodiment, since the load is likely to be uniform for each color of the data lines 14R, 14G, and 14B, it is possible to prevent deterioration in display quality due to the difference in load.

Note that in the embodiment, the transistor 124 is disposed between the transistor 121 and the OLED 130, but sufficiently be disposed at any point in a path from the feed line 16 to the common electrode 118 through the OLED 130.

In the present embodiment, the three transistors 121, 122, and 124 are provided in the pixel circuit 600R, 600G, or 600B, but the transistor 124 can be omitted. Also in a configuration in which the transistor 124 is omitted in the pixel circuit 600R, 600G, or 600B, since the feed line 16 and the scan line 12 are provided, it is possible to ensure the area through which the light is transmitted by overlapping the scan line 12b with the feed line 16 in plan view in the transverse wiring section 162 compared to the configuration in which the scan line 12b and the feed line 16 do not overlap each other.

The number of transistors constituting each of the pixel circuits 600R, 600G, and 600B may be four or more. For example, a compensation transistor that connects and disconnects the source node and the drain node of the transistor 121 may be provided in order to compensate for the threshold of the transistor 121, or a resetting transistor that resets an anode potential of the OLED 130 may be provided.

Regardless of the compensation transistor or the resetting transistor, it is sufficient to dispose an additional control line so as to overlap the feed line 16 in plan view in the transverse wiring section 162 similarly to the scan line 12 or the control line 15.

Then, an electronic apparatus to which the electro-optical device 10 according to the embodiment is applied will be described. The electro-optical device 10 is suitable for a transmissive display small in pixel size and high in definition. Therefore, a head-mounted display will be described as an example of the electronic apparatus.

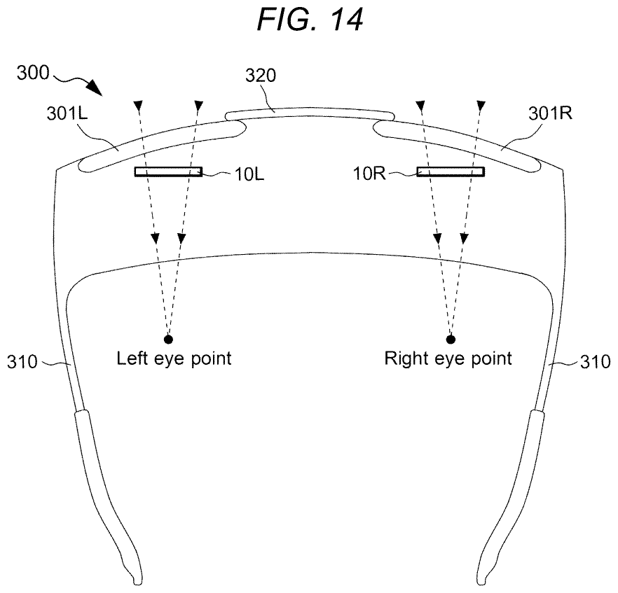

FIG. 13 is a diagram illustrating an appearance of the head-mounted display, and FIG. 14 is a diagram illustrating an optical configuration of the head-mounted display.

First, as illustrated in FIG. 13, the head-mounted display 300 includes temples 310, a bridge 320, and lenses 301L, 301R similarly in appearance to general glasses. Further, as illustrated in FIG. 14, the head-mounted display 300 includes an electro-optical device 10L for a left eye and an electro-optical device 10R for a right eye that are disposed near the bridge 320 and at a back side of the lenses 301L, 301R (lower side in the drawing).

The display surface of the electro-optical device 10L and the display surface of the electro-optical device 10R are orthogonal to a direction to which a wearer of the head-mounted display 300 faces.

In this configuration, the wearer can observe the display images by the electro-optical devices 10L, 10R in a see-through state in which the display images are superimposed on an outside view.

Further, in the head-mounted display 300, when the electro-optical device 10L displays an image for the left eye and the electro-optical device 10R displays an image for the right eye out of binocular images with parallax, the wearer can perceive the displayed image as if the displayed image had a depth or a stereoscopic effect.

In reality, an optical system such as a lens is provided in order to visually recognize with efficiency the display by the electro-optical device 10L and the display by the electro-optical device 10R, but such an optical system is not illustrated in order to avoid complication of the drawing.

Note that regarding the electronic apparatus including the electro-optical device 10, the electro-optical device can be applied to a transmissive display unit such as an electronic viewfinder in a video camera, a lens-interchangeable digital camera, or a display unit of a smart watch or a wearable device, in addition to the head-mounted display 300.

The following aspects, for example, are figured out from the aspects exemplified above.

An electro-optical device according to ASPECT 1 includes a feed line disposed along a first direction, a scan line disposed along the feed line, a first data line disposed along a second direction crossing the first direction, a second data line disposed along the second direction, a first pixel circuit disposed corresponding to an intersection of the scan line and the first data line, a second pixel circuit disposed corresponding to an intersection of the scan line and the second data line, and a feed line wiring section disposed in a region between the first pixel circuit and the second pixel circuit in the first direction in plan view and configured to transmit light, wherein the feed line and the scan line are disposed in the feed line wiring section, the first pixel circuit includes a first transistor, a second transistor, and a first light emitting element, the second pixel circuit includes a third transistor, a fourth transistor, and a second light emitting element, the second transistor is set in an ON state or an OFF state in accordance with a voltage of the scan line between the first data line and a first gate node of the first transistor, the fourth transistor is set in an ON state or an OFF state in accordance with a voltage of the scan line between the second data line and a second gate node of the third transistor, the first transistor controls a current being supplied from the feed line to the first light emitting element in accordance with a voltage of the first gate node, the third transistor controls a current being supplied from the feed line to the second light emitting element in accordance with a voltage of the second gate node, and the feed line and the scan line overlap each other in plan view in the feed line wiring section.

According to the electro-optical device related to ASPECT 1, since the feed line and the scan line along the first direction overlap each other in plan view between the first pixel circuit and the second pixel circuit, it is possible to ensure a larger area through which the light from the external world is transmitted compared to a configuration in which the feed line and the scan line do not overlap each other.

In ASPECT 1, the X direction is an example of a “first direction,” and the Y direction is an example of a “second direction.” An expression “B disposed along A” means that B is not required to be entirely disposed along A, and B is partially disposed along A.

The data line 14G corresponding to a certain pixel cluster section 60 is an example of the “first data line,” and the data line 14G corresponding to the pixel cluster section 60 located at the right side of that pixel cluster section 60 is an example of the “second data line.” The pixel circuit 600G provided to a certain pixel cluster section 60 is an example of the “first pixel circuit,” and the pixel circuit 600G provided to the pixel cluster section 60 located at the right side of that pixel cluster section 60 is an example of the “second pixel circuit.”

The transistor 121 is an example of the “first transistor” and the “third transistor,” and the transistor 122 is an example of the “second transistor” and the “fourth transistor.” The OLED 130 is an example of the “light emitting element.”

The electro-optical device according to ASPECT 2 as a specific aspect of ASPECT 1 is further provided with a control line disposed along the feed line, wherein the control line is disposed in the feed line wiring section, the first pixel circuit includes a fifth transistor between the feed line and the first light emitting element, the second pixel circuit includes a sixth transistor between the feed line and the second light emitting element, the fifth transistor and the sixth transistor are set in an ON state or an OFF state in accordance with a voltage of the control line, the first transistor controls a current being supplied through the first light emitting element when the fifth transistor is in the ON state, the third transistor controls a current being supplied through the second light emitting element when the sixth transistor is in the ON state, and the feed line and the control line overlap each other in plan view in the feed line wiring section.

According to the electro-optical device related to ASPECT 2, since the control line further overlaps the feed line and the scan line along the same direction in plan view between the first pixel circuit and the second pixel circuit, it is possible to ensure a large area through which the light from the external world is transmitted also in a configuration in which the fifth transistor and the sixth transistor control the light emission period by the light emitting element.

The transistor 124 is an example of the “fifth transistor” and the “sixth transistor.”

In the electro-optical device according to ASPECT 3 as another specific aspect of ASPECT 1, the feed line is linearly formed along the first direction from the first pixel circuit to the second pixel circuit in a single wiring layer.

According to the electro-optical device related to ASPECT 3, since the resistance of the feed line is reduced, it is possible to suppress deterioration in display quality due to a voltage drop in the feed line.

Note that the expression that a wiring line is formed in a single wiring layer means that the wiring line is formed by patterning a single wiring layer instead of coupling wiring lines formed of a plurality of wiring layers to each other with a contact hole.

An electro-optical device according to ASPECT 4 includes a feed line disposed along a first direction, a first scan line disposed along the feed line, a second scan line disposed along the feed line, a first data line disposed along a second direction crossing the first direction, a second data line disposed along the second direction, a first pixel circuit disposed corresponding to an intersection of the first scan line and the first data line, a second pixel circuit disposed corresponding to an intersection of the first scan line and the second data line, a third pixel circuit disposed corresponding to an intersection of the second scan line and the first data line, a fourth pixel circuit disposed corresponding to an intersection of the second scan line and the second data line, and a data line wiring section disposed in a region between a pair of the first pixel circuit and the second pixel circuit and a pair of the third pixel circuit and the fourth pixel circuit in the second direction in plan view, and configured to transmit light, wherein the first pixel circuit includes a first transistor, a second transistor, and a first light emitting element, the second pixel circuit includes a third transistor, a fourth transistor, and a second light emitting element, the third pixel circuit includes a fifth transistor, a sixth transistor, and a third light emitting element, the fourth pixel circuit includes a seventh transistor, an eighth transistor, and a fourth light emitting element, the second transistor is set in an ON state or an OFF state in accordance with a voltage of the first scan line between the first data line and a first gate node of the first transistor, the fourth transistor is set in an ON state or an OFF state in accordance with a voltage of the first scan line between the second data line and a second gate node of the third transistor, the sixth transistor is set in an ON state or an OFF state in accordance with a voltage of the second scan line between the first data line and a third gate node of the fifth transistor, the eighth transistor is set in an ON state or an OFF state in accordance with a voltage of the second scan line between the second data line and a fourth gate node of the seventh transistor, the first transistor controls a current being supplied from the feed line to the first light emitting element in accordance with a voltage of the first gate node, the third transistor controls a current being supplied from the feed line to the second light emitting element in accordance with a voltage of the second gate node, the fifth transistor controls a current being supplied from the feed line to the third light emitting element in accordance with a voltage of the third gate node, the seventh transistor controls a current being supplied from the feed line to the fourth light emitting element in accordance with a voltage of the fourth gate node, and the first data line and the second data line overlap each other in plan view in the data line wiring section.

According to the electro-optical device related to ASPECT 4, since the first data line and the second data line along the Y direction overlap each other in plan view between the pair of the first pixel circuit and the second pixel circuit, and the pair of the third pixel circuit and the fourth pixel circuit, it is possible to ensure a larger area through which the light from the external world is transmitted, compared to a configuration in which the first data line and the second data line do not overlap each other.

In ASPECT 4, the data line 14R corresponding to a certain pixel cluster section 60 is an example of the “first data line,” and the data line 14B corresponding to that pixel cluster section 60 is an example of the “second data line.” Further, the scan line 12 corresponding to a certain pixel cluster section 60 is an example of the “first scan line,” and the scan line 12 corresponding to the pixel cluster section 60 located at the lower side of that pixel cluster section 60 is an example of the “second scan line.”

The pixel circuits 600R and 600B provided to a certain pixel cluster section 60 are examples of the “first pixel circuit” and the “second pixel circuit” in order, and the pixel circuits 600R and 600B provided to the pixel cluster section 60 located at the lower side of that pixel cluster section 60 are examples of the “third pixel circuit” and the “fourth pixel circuit” in order.

The transistor 121 is an example of the “first transistor,” the “third transistor,” the “fifth transistor,” and the “seventh transistor,” and the transistor 122 is an example of the “second transistor,” the “fourth transistor,” the “sixth transistor,” and the “eighth transistor.”

In the electro-optical device according to ASPECT 5 as a specific aspect of ASPECT 4, the first light emitting element and the third light emitting element correspond to first colored light, and the second light emitting element and the fourth light emitting element correspond to second colored light.

According to the electro-optical device related to ASPECT 5, since the data lines correspond to the same colored light, it is possible to uniform loads such as a resistance and a parasitic capacitance in the data lines for the respective colors.

Note that the expression that the light emitting element corresponds to the first colored light includes when the light emitting element emits the white light and the first colored light is emitted through a color filter, when the light emitting element emits the first colored light, and so on.

An electronic apparatus according to ASPECT 6 includes the electro-optical device according to any one of ASPECTS 1 to 5.

What is claimed is:

1. An electro-optical device comprising:
a feed line disposed along a first direction;
a scan line disposed along the feed line;
a first data line disposed along a second direction crossing the first direction;
a second data line disposed along the second direction;
a first pixel circuit disposed corresponding to an intersection of the scan line and the first data line;
a second pixel circuit disposed corresponding to an intersection of the scan line and the second data line; and
a feed line wiring section disposed in a region between the first pixel circuit and the second pixel circuit in the first direction in plan view and configured to transmit light, wherein
the feed line and the scan line are disposed in the feed line wiring section,
the first pixel circuit includes
a first transistor, a second transistor, and a first light emitting element,
the second pixel circuit includes
a third transistor, a fourth transistor, and a second light emitting element,
the second transistor is set in an ON state or an OFF state in accordance with a voltage of the scan line between the first data line and a first gate node of the first transistor,
the fourth transistor is set in an ON state or an OFF state in accordance with a voltage of the scan line between the second data line and a second gate node of the third transistor,
the first transistor controls a current being supplied from the feed line to the first light emitting element in accordance with a voltage of the first gate node,
the third transistor controls a current being supplied from the feed line to the second light emitting element in accordance with a voltage of the second gate node, and
the feed line and the scan line overlap each other in plan view in the feed line wiring section.

2. The electro-optical device according to claim 1, further comprising
a control line disposed along the feed line, wherein
the control line is disposed in the feed line wiring section,
the first pixel circuit includes a fifth transistor between the feed line and the first light emitting element,
the second pixel circuit includes a sixth transistor between the feed line and the second light emitting element,
the fifth transistor and the sixth transistor are set in an ON state or an OFF state in accordance with a voltage of the control line,
the first transistor controls a current being supplied through the first light emitting element when the fifth transistor is in the ON state,
the third transistor controls a current being supplied through the second light emitting element when the sixth transistor is in the ON state, and
the feed line and the control line overlap each other in plan view in the feed line wiring section.

3. The electro-optical device according to claim 1, wherein
the feed line is linearly formed along the first direction from the first pixel circuit to the second pixel circuit in a single wiring layer.

4. An electro-optical device comprising:
a feed line disposed along a first direction;
a first scan line disposed along the feed line;
a second scan line disposed along the feed line;
a first data line disposed along a second direction crossing the first direction;
a second data line disposed along the second direction;
a first pixel circuit disposed corresponding to an intersection of the first scan line and the first data line;
a second pixel circuit disposed corresponding to an intersection of the first scan line and the second data line;
a third pixel circuit disposed corresponding to an intersection of the second scan line and the first data line;
a fourth pixel circuit disposed corresponding to an intersection of the second scan line and the second data line; and
a data line wiring section disposed in a region between a pair of the first pixel circuit and the second pixel circuit and a pair of the third pixel circuit and the fourth pixel circuit in the second direction in plan view, and configured to transmit light, wherein
the first pixel circuit includes
a first transistor, a second transistor, and a first light emitting element,
the second pixel circuit includes
a third transistor, a fourth transistor, and a second light emitting element,
the third pixel circuit includes
a fifth transistor, a sixth transistor, and a third light emitting element,
the fourth pixel circuit includes
a seventh transistor, an eighth transistor, and a fourth light emitting element,
the second transistor is set in an ON state or an OFF state in accordance with a voltage of the first scan line between the first data line and a first gate node of the first transistor,
the fourth transistor is set in an ON state or an OFF state in accordance with a voltage of the first scan line between the second data line and a second gate node of the third transistor,
the sixth transistor is set in an ON state or an OFF state in accordance with a voltage of the second scan line between the first data line and a third gate node of the fifth transistor,
the eighth transistor is set in an ON state or an OFF state in accordance with a voltage of the second scan line between the second data line and a fourth gate node of the seventh transistor,
the first transistor controls a current being supplied from the feed line to the first light emitting element in accordance with a voltage of the first gate node,
the third transistor controls a current being supplied from the feed line to the second light emitting element in accordance with a voltage of the second gate node,
the fifth transistor controls a current being supplied from the feed line to the third light emitting element in accordance with a voltage of the third gate node,
the seventh transistor controls a current being supplied from the feed line to the fourth light emitting element in accordance with a voltage of the fourth gate node, and
the first data line and the second data line overlap each other in plan view in the data line wiring section.

5. The electro-optical device according to claim 4, wherein
the first light emitting element and the third light emitting element correspond to first colored light, and
the second light emitting element and the fourth light emitting element correspond to second colored light.

6. An electronic apparatus comprising
the electro-optical device according to claim 1.
